(19) United States
(12) Patent Application Publication
(10) Pub. No.: US 2012/0167142 A1
(43) Pub. Date: Jun. 28, 2012

(54) METHODS AND APPARATUSES TO FACILITATE PRESELECTION OF PROGRAMMING PREFERENCES

(75) Inventor: Andrew Hey, Keighley (GB)

(73) Assignee: Eldon Technology Limited, Keighley (GB)

(21) Appl. No.: 12/977,507

(22) Filed: Dec. 23, 2010

(51) Int. Cl. H04N 5/445

(52) U.S. Cl. 725/44

(57) ABSTRACT

Described herein are techniques for communicating information regarding generated programming recommendations to a communication device of a user. The user may provide a selection at the communication device of one or more programs corresponding to one or more of the programming recommendations. Timers may be set at an entertainment device based on the user selection(s), thereby facilitating preselection of video and/or audio programming preferences.

### BACKGROUND

Users of television entertainment systems—particularly subscription-based television systems such as those offered by cable, fiber, and satellite television providers—often have a large number of channels of programming content available to them. To help users to navigate the volume of available programming, electronic program guides (“EPG's”) have become commonplace. EPG's present information—often in an interactive view—about content that is available during a present time and for some amount of time into the future. Digital video recorders (“DVR's”) have also become commonplace and, in conjunction with EPG's, provide users with the ability to record current programming and to select shows in advance for recording.

Although EPG's provide television users with a wealth of useful information about present and future programming, navigating an EPG to find preferred programs to watch or record can still be very time-consuming. Further, television programs typically begin at the same time intervals across multiple channels (e.g., at half hour increments), and a user may miss out on the beginning of a program while navigating or browsing an EPG for the next preferred program to watch after a first preferred program has terminated. If a person has a busy work schedule and limited television viewing time at home each day, they may not have time or find it worthwhile to navigate through all of the programming that is available to watch or record during a given time period. As a result, the person may just stick to a few channels or programs that they prefer. Further, once a person is watching a given channel that a preferred program is on, they may be less apt to navigate the EPG for other programming once the program finishes, and could thus miss a program that would have been preferred, had they been informed about it.

### BRIEF DESCRIPTION OF THE DRAWINGS

The same number represents the same element or same type of element in all drawings.

FIG. 1 illustrates an embodiment of a content distribution environment.

FIG. 2 illustrates an embodiment of a content distribution environment that includes a recommendations engine.

FIG. 3 illustrates an embodiment of a content distribution environment that includes place-shifting.

FIG. 4 illustrates an embodiment of a process, in a content distribution network, for generating and transmitting programming recommendations, and for setting a timer based on a user selection.

FIG. 5 illustrates an embodiment of a communication device.

FIG. 6 illustrates an embodiment of an entertainment device.

FIG. 7 illustrates an example screen shot of an embodiment of an interactive interface that facilitates user selection of recommended programming to request that one or more timers be set.

### DETAILED DESCRIPTION

The various embodiments described herein generally provide methods, apparatuses, and systems for providing communication—between devices in a content distribution network—of information regarding programming recommendations. A user may provide input with respect to programming recommendations, and timers may be set at an entertainment device based on the received user input. Thus, the embodiments described herein facilitate preselection of video and/or audio programming preferences.

In one embodiment, programming recommendations are generated. The programming recommendations correspond to one or more programs that are scheduled to be broadcast to an entertainment device—via a content distribution network—during a predetermined future time period. Information regarding the programming recommendations is transmitted to a communication device, which may be a separate device from the entertainment device. The information may include scheduling information regarding the recommended programs. One or more user inputs or user selections, which correspond to one or more of the recommended programs, may be received from the communication device. A received user selection may request that a timer be set at the entertainment device to perform a task associated with the program. An instruction is generated, requesting that the timer be set at the entertainment device.

In another embodiment, a communication device is provided. The communication device includes a communications interface, which receives scheduling information regarding recommended programs. Each of the recommended programs is scheduled to be broadcast to an entertainment device via a content distribution network during a predetermined future time period. The communication device also includes a display module that presents the scheduling information regarding the recommended programs. The device further includes a user input interface, which receives a selection from a user of one or more of the recommended programs. The user selection requests that a timer be set at the entertainment device to perform a task associated with the selected program. The communications interface initiates transmission of the user selection to the entertainment device. Upon receiving the transmission of the user selection, the entertainment device is configured to set the timer to take an action with respect to the selected program.

In another embodiment, an entertainment device is provided. The entertainment device includes a communications interface that is communicatively connected to a video content distribution network. The communications interface receives video programming from a content source. The entertainment device also includes a presentation interface that outputs received video programming to a presentation device for display thereon. The entertainment device further includes a processor, which generates programming recommendations that correspond to recommended programs. The recommended programs are scheduled to be broadcast to the entertainment device during a predetermined future time period. The communications interface is also communicatively coupled to a communications network. The communications interface initiates transmission of scheduling information regarding the plurality of programming recommendations to a communication device. The communication device is a separate device from the entertainment device. The communications interface receives a user selection of a recommended program from the communication device. Responsive to the receipt of the user selection, the processor of the entertainment device sets a timer, corresponding to the scheduling information of the selected program, to perform a task that the user selection requests. The processor then, according to the timer, executes the task.

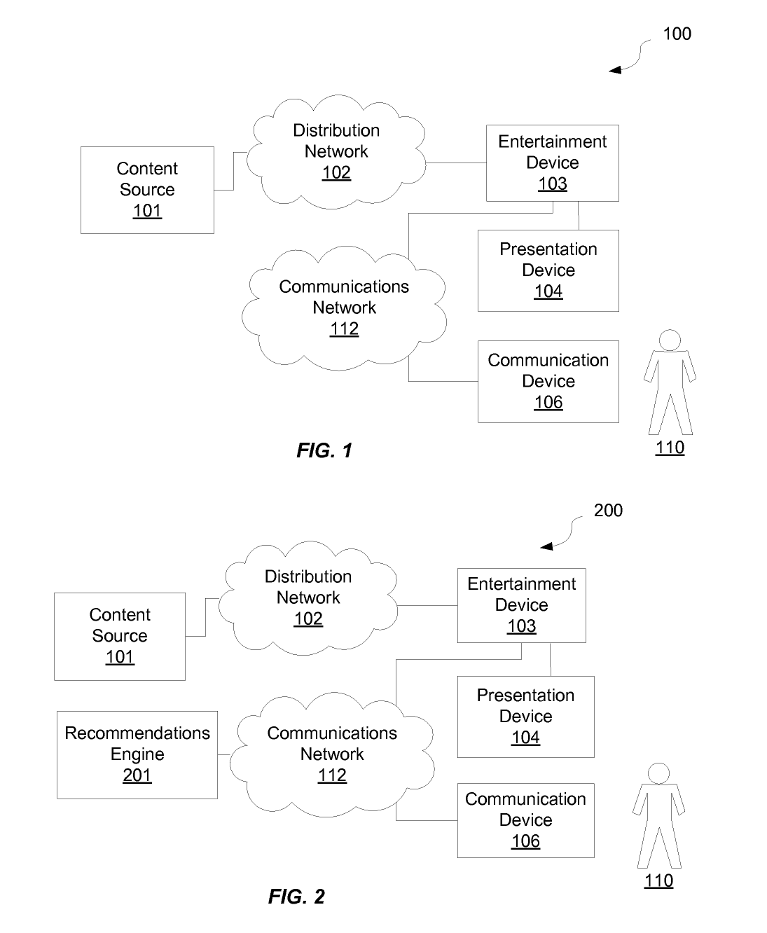

FIG. 1 illustrates an example of a content distribution environment 100. In order to facilitate preselection of programming preferences, elements of the content distribution environment 100 are configured to present video and/or audio streams to a user 110, to generate programming recommendations, and to provide a user with interactive scheduling information according to embodiments described herein. Content distribution environment 100 may include elements or components that are not illustrated for the sake of brevity.

The content source 101 comprises any source or sources of video and/or audio signals. The content source 101 may be a television station that generates and provides television video content, or may be a television service—e.g., a satellite television provider, cable television provider, fiber optic television provider, internet television provider, or other video content distributor—that provides retransmission of television signals and/or video content. In some embodiments, content source 101 may be an audio provider—e.g., a satellite radio provider or other radio provider. While reference may be made to video distribution or television distribution throughout this application, it will be understood that claimed features may be compatible with an audio distribution environment or other audio and/or video distribution environment and effective when implemented therein.

The distribution network 102 may comprise any type of network utilized between the content source 101 and the entertainment device 103 to distribute television or other audio and/or video signals. Video signals that are distributed across the distribution network 102 may comprise analog or digital signals. Examples of video formats include moving pictures expert group (MPEG), Flash, Windows Media, and other digital or analog formats. The signals may comprise video data, audio data and/or textual data. The signals may also include metadata that provides supplementary information to the video and/or audio data (such as closed captioning and/or program guide data). Metadata may also facilitate processing the signals and/or provide additional interactivity with the content. Some examples of distribution networks include television distribution networks (e.g., over-the-air, satellite, cable, and fiber-optic television networks), audio distribution networks, wireless communication networks, public switched telephone networks (PSTN), local area networks (LAN), wide area networks (WAN), and the internet, any of which would comprise a distribution network 102 when configured to provide a medium for distribution of video and/or audio signals from a content source 101 to entertainment device 103. The distribution network 102 may utilize any desired combination of wired (e.g., cable and fiber) and/or wireless (e.g., cellular, satellite, microwave, and radio frequency) communication mediums and any desired network topology (or topologies when multiple mediums are utilized).

In various embodiments, the entertainment device 103 may communicate with the distribution network 102 through a wired or wireless connection. The entertainment device 103 may, in some embodiments, be coupled to one or more connectivity devices (not shown) such as an antenna, router, switch, modem and/or other apparatus that is configured to interface between the entertainment device 103 and the distribution network 102. Such connectivity devices may be either integrated into the entertainment device 103 or external thereto.

The entertainment device 103 may be any device that is configured to receive video and/or audio content from the content source 101 through the distribution network 102. In some configurations, the entertainment device 103 is a set top box or other receiver, which is configured to receive, decrypt, demodulate, and/or decode digital or analog signals from the content source 101 for presentation by the presentation device 104. Entertainment device 103 may optionally include DVR (digital video recorder) hardware and/or software that captures and records video content received via the distribution network 102, from other attached devices (not shown), or via communications network 112. The entertainment device 103 may also include conditional access hardware and/or software which control access to all or a portion of the available content. Additionally, the entertainment device may have a “back channel” to communicate data (e.g., diagnostic, billing, payment, or other data) to the content source 101. The back channel may be the communications network 112 or may be a separate communications channel. The entertainment device 103 may operate in conjunction with a remote control (not shown), which allows a user 110 to provide remote input to the entertainment device 103, the presentation device 104, and/or other devices not depicted. In some embodiments, entertainment device 103 may comprise the components illustrated in the entertainment device of FIG. 6, which will be described in more detail hereafter.

The entertainment device 103 is connected, through a wired or wireless connection, to presentation device 104 and outputs audio and/or video content thereto. In some embodiments, the entertainment device 103 and the presentation device 104 may be integrated into a single apparatus that is configured to receive, process, and present content from the content source 101 (e.g., audio receiver, television, computer, tablet PC, portable handheld electronic device, or other entertainment device that includes a display or other presentation capabilities). In other embodiments, received content may be decrypted, demodulated and/or decoded at the entertainment device 103 before being output to the presentation device 104, or the content may be provided from the entertainment device 103 to the presentation device 104 in a format that requires additional demodulation or decoding at the presentation device 104. Examples of presentation devices that are compatible with various embodiments include television sets, display monitors, projectors, computer screens, portable electronic devices, and other display devices.

Entertainment device 103 and a communication device 106 are each communicatively connected to a communications network 112. In some embodiments, the communications network 112 comprises a data communications network, such as the internet. In other embodiments, communications network 112 may be implemented through a public switched telephone network (PSTN), LAN, WAN, or other wired (including fiber, cable, DSL, ISDN, T1, and the like) or wireless (including microwave, radio frequency, Wi-Fi, WiMax, cellular, and the like) network or combination thereof. In some embodiments, communications network 112 and distribution network 102 may be the same network.

Communication device 106 may be any device that is communicatively connected to the communications network 112 and which is configured to provide one or more functionalities described herein. For example, communication device 106 may be a laptop computer, a desktop computer, cell phone, handheld computing device, tablet computing device, a set top box, or other device. In some embodiments, communication device 106 may be a mobile device of user 110 which, for at least a portion of the day, is in a geographically separate location from the entertainment device 103 of the user 110.

In some embodiments, entertainment device 103 may generate programming recommendations, which correspond to recommended programs that are scheduled to be broadcast to the entertainment device 103 from the content source 101 via distribution network 102. The recommended programs correspond to a predetermined future time period. The entertainment device may communicate information regarding the programming recommendations to communication device 106. The communicated information may include scheduling information regarding the recommended programs. The communication device 106 may receive one or more user selections, or other user inputs, corresponding to one or more of the programming recommendations and transmit the user selection(s) to the entertainment device 103 for processing thereon. The user selection(s) may request that a timer be set at the entertainment device 103 to perform a task associated with the selected program(s). Timers may be recording timers, auto-tune timers, reminder timers, or place-shifting timers, each of which is discussed in more detail herein. Upon receiving the user selection requesting that a timer be set, a processor or other processing element of the entertainment device 103 may set the timer and then execute the timer at the corresponding time.

FIG. 2 illustrates a second video content distribution environment 200 that includes devices, systems, and networks that provide for embodiments described herein. In addition to the same or similar elements as those depicted in FIG. 1, FIG. 2 also includes a recommendations engine 201. Recommendations engine 201 may be implemented as one or more servers or other computing devices and/or other hardware components. Recommendations engine is configured to process recommendations according to embodiments described herein. In some embodiments, recommendations engine 201 may be implemented via cloud computing mechanisms and corresponding devices, or by other distributed computing and/or virtualized computing hardware and systems.

In some embodiments, rather than the entertainment device 103 generating programming recommendations, generation of programming recommendations may be performed by the recommendations engine 201. Viewing preference and/or viewing history (or listening preferences and/or history, in the case of an audio distribution system) may be communicated to the recommendations engine 201 from the entertainment device 103, or from content source 101. Alternatively, a user's viewing preferences may be communicated to the recommendations engine 201 by the user through means other than the entertainment device 103, for example, through a web interface. The recommendations engine 201 may generate programming recommendations based on the received user preferences and/or user history. In such embodiments, the recommendations engine 201 transmits information regarding the generated programming recommendations to the communication device 106. The transmitted information includes scheduling information regarding recommended programs.

After a user selection or other input of the user is received at the communication device, the user selection may be communicated to the recommendations engine 201. The recommendations engine 201 may then provide that a timer be set that is associated with the selected program. In some embodiments, the recommendations engine 201 may communicate timer data or user selection data to the entertainment device 103 so that the entertainment device 103 sets the timer. In at least one embodiment, the recommendations engine 201 may set a timer to perform the task at the recommendations engine 201. In such embodiments, the recommendations engine may have access to the programming content from the content source 101. In other embodiments, the communications device 106 communicates the user selection and corresponding data directly to entertainment device 103.

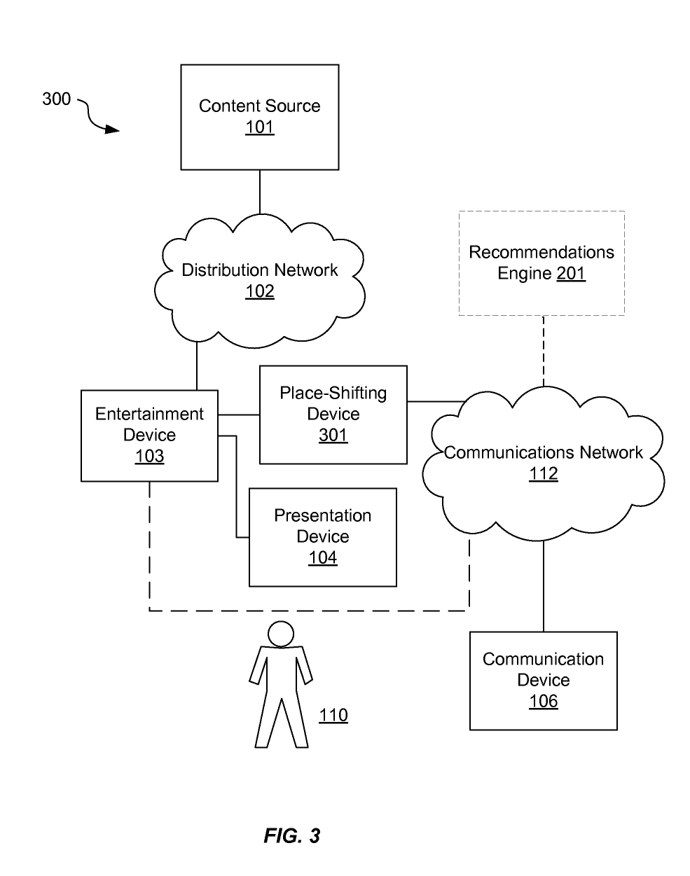

FIG. 3 illustrates an embodiment of a third video content distribution environment 300. In FIG. 3, recommendations engine 201 is depicted with a dashed line to indicate that some embodiments may utilize a recommendations engine similar to environment 200. In other embodiments, recommendation generation and processing of user selections is conducted at the entertainment device 103—with no recommendations engine—similarly as is depicted in environment 100 of FIG. 1. In addition to the same or similar elements as those depicted in FIG. 1 and/or FIG. 2 and described elsewhere herein, video content distribution environment 300 further includes a place-shifting device 301.

A place-shifting device 301 is an apparatus that transmits, re-transmits, or relays video content from entertainment device 103 to a remote device, e.g., communication device 106, through communications network 112. The communication device 106 may, in some embodiments, be in a location that is geographically separate from the entertainment device 103. In some embodiments, place-shifting device 301 may be integrated with entertainment device 103 as one device; in others, it may be communicatively coupled to the entertainment device 103.

As one example of place-shifting functionality, the place-shifting device 301 may transmit from the entertainment device 103, through the communications network 112 to the communication device 106, in real-time or near real-time, one or more streams of video content that are being received from the content source 101 at the entertainment device 103. To elaborate further on this example, content is first received at the entertainment device 103 from the content source 101 through the distribution network 102 and decrypted, transcoded, decoded and/or partially decoded at the entertainment device 103. Content is then transmitted from the entertainment device 103 to the place-shifting device 301 in either an encoded or decoded format. In some embodiments, the place-shifting device 301 may transcode and/or repackage the stream in a format that is suitable for transmission across the communications network 112. The place-shifting device 301 may also utilize security features, such as various known encryption techniques, when encoding the video stream in order to prevent interception or unauthorized viewing of the video content. Commercial examples of place-shifting devices include some of the SLINGBOX line of products that are produced and marketed by Sling Media, Inc. of Foster City, Calif.

In some embodiments, the place-shifting device 301 has the ability to transmit instructions, i.e. control commands, received from a user of the communication device 106 through the communications network 112, to the entertainment device 103 in order to provide the user with remote interaction with the entertainment device 103. In some embodiments, a user may, with the communication device 106, instruct the place-shifting device 301 through the communications network 112 to provide a control command to the entertainment device 103 to begin place-shifting selected content to the communication device 106. Additionally, in at least one embodiment, an instruction may be provided from the communication device 106 to the entertainment device 103, via the place-shifting device 301, to set a timer to place-shift specified content at a specified future time. In one or more embodiments, instructions may be sent from the communication device 106, via the place-shifting device 301, to the entertainment device 103 to set recording timers to record selected recommended programs at the entertainment device, to set reminders to remind a user that a selected recommended program is going to begin, or to schedule the entertainment device 103 to auto-tune to a selected recommended program at a particular time. In some embodiments, such instructions may be transmitted from the place-shifting device 301 to the entertainment device 103 via a wired or wireless optical connection (e.g., IR), via radio frequency, via a wired or wireless network communications interface, or via commands sent through a connecting cable, for example, through a USB connection or a CEC (consumer electronics control) bus of an HDMI® connection. In at least one embodiment, instructions may be provided directly to the entertainment device 103 from the communication device 106 via the communications network 112. The connection between entertainment device 103 and communication network 112 is depicted as a dashed line because in some embodiments, entertainment device may have a direct connection to communications network 112, whereas, in others, the entertainment device is not directly connected.

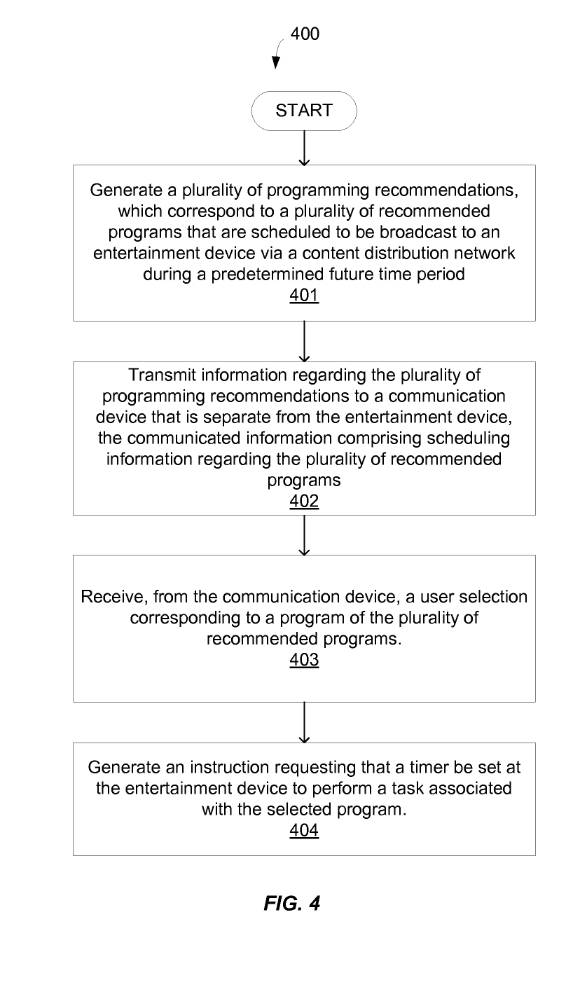

FIG. 4 depicts an embodiment of a process 400 for providing pre-selection of programming preferences for a user of both an entertainment device and a communication device. The process includes generating a plurality of programming recommendations, which correspond to a plurality of recommended programs that are scheduled to be broadcast to an entertainment device via a content distribution network during a predetermined future time period (operation 401). In at least one embodiment, the content distribution network is a video content distribution network. In at least one embodiment, the plurality of programming recommendations may be generated at a recommendations engine. In another embodiment, the programming recommendations may be generated at the entertainment device.

In some embodiments, the predetermined future time period may be a daily time period in which a user watches TV, and may recur daily or on a fixed set of days each week. For example, the predetermined future time period may comprise a set number of hours each day, e.g., six o'clock to eight o'clock each evening. In some embodiments, recurrence of the time period may be limited to a fixed set of days each week (e.g., weekdays, or Monday through Thursday). The predetermined time period may be different for different days of the week based on the user's weekly viewing schedule. The predetermined future time period may be fixed, may be specified by a user, or may be automatically generated based on a tracking of the user's regular viewing times.

Moreover, viewing recommendations may be transmitted to a communication device of a user at a set time on each of the fixed set of days. The set time for transmitting the recommendations may be configurable by a user through a configuration application provided at the user's entertainment device, communication device, via the web, or the like. As an example of one such embodiment, a user may regularly view television from six until eight each evening, Monday through Thursday. The user may desire to review and provide selections of each evening's viewing recommendations during the user's lunch break that day. The user may therefore configure viewing recommendations to be sent to the user's communication device at or by eleven o'clock AM each day, for example. The user may then utilize his/her communication device to set viewing and/or recording lineups for the evening during the lunch break and be able to kick back and watch the selected programming that evening.

Recommendations for a user may be generated in any number of ways, as desired by the implementer of an embodying system and/or the user. For example, recommendations may be automatically generated based upon the user's recording history and/or rental history and/or viewing habits, which may be stored as user history data either at local storage of the entertainment device or at a remote storage device. The user's viewing or recording history may, for example, suggest that the user likes a certain actor, a certain director, and/or a certain genre or theme of programs (comedy, action, horror, drama, etc.). As additional examples, the user's history may indicate that he/she watches a particular program each week, likes a particular sport or sports team, or is interested in a specific subject matter. This information may be used to identify other programs having the same or similar characteristics, which then become recommendations or are utilized to generate recommendations for the user. Alternatively, a user may customize their recommendations by specifying particular programs, movies, series, channels, actors, genres, directors, and the like. Some implementations may utilize a hybrid of both automatically generating recommendations based on user history to and allowing a user to customize or tweak the generated recommendations.

In some embodiments, recommendations may be user specific. For example, a husband and wife, or different roommates, may use the same entertainment device to view television but may have different viewing preferences. The entertainment device may distinguish between the users through various mechanisms, and individualized recommendations may be provided accordingly. For example, the users may have separate accounts and provide a user id, a password and/or a PIN to distinguish themselves at the entertainment device. Alternatively, users may be identified biometrically (e.g., by fingerprint or by an image capture device that distinguishes face, body type or other features) or may be identified based on proximity of an identifiable device that is associated with the user, such as an RFID card, a Bluetooth™-enabled cell phone, or other device.

The process 400 further includes transmitting information regarding the plurality of programming recommendations to a communication device (operation 402). The communicated information includes scheduling information regarding the recommended programs for the predetermined future time period. In some embodiments, the communication device is a separate device from the entertainment device, although it may pertain to the same user. In some embodiments, the communication device may also be geographically separate from the entertainment device. For each time slot of the predetermined future time period, a number of different recommended programs may be communicated to the communication device. The recommendations may be presented at the communication device to the user in various formats or mediums, which are discussed elsewhere herein.

The process 400 also includes receiving, from the communication device, a user selection corresponding to one of the plurality of recommended programs (operation 403). The user selection may request that a timer be set at the entertainment device corresponding to a selected program.

The process 400 further includes generating an instruction requesting that a timer be set at the entertainment device to perform a task associated with the selected program (operation 404). The generated instruction may be generated either at a recommendations engine, or at the entertainment device, depending on the configuration of an embodying system. In some embodiments, the timer may be a recording timer to record the program on a DVR of the entertainment device during a time slot corresponding to the scheduling information of the program. Alternatively, the timer may be an auto-tune timer to automatically tune the entertainment device to the program at a time that is associated with or proximal to a beginning of the time slot of the program. In other embodiments, the timer could be a reminder timer, which triggers a reminder to be presented to the user at a time that is associated with a beginning time of program (e.g., five minutes prior thereto or at a similarly proximal time). A reminder could be presented to a user via a popup or overlay presented on a presentation device, or could be communicated to the user's communication device, emailed to the user, sent to a mobile device via SMS, or otherwise presented to the user. In at least one embodiment, the timer is associated with place-shifting the recommended program to the communication device at a time associated with a beginning of the time slot of the program.

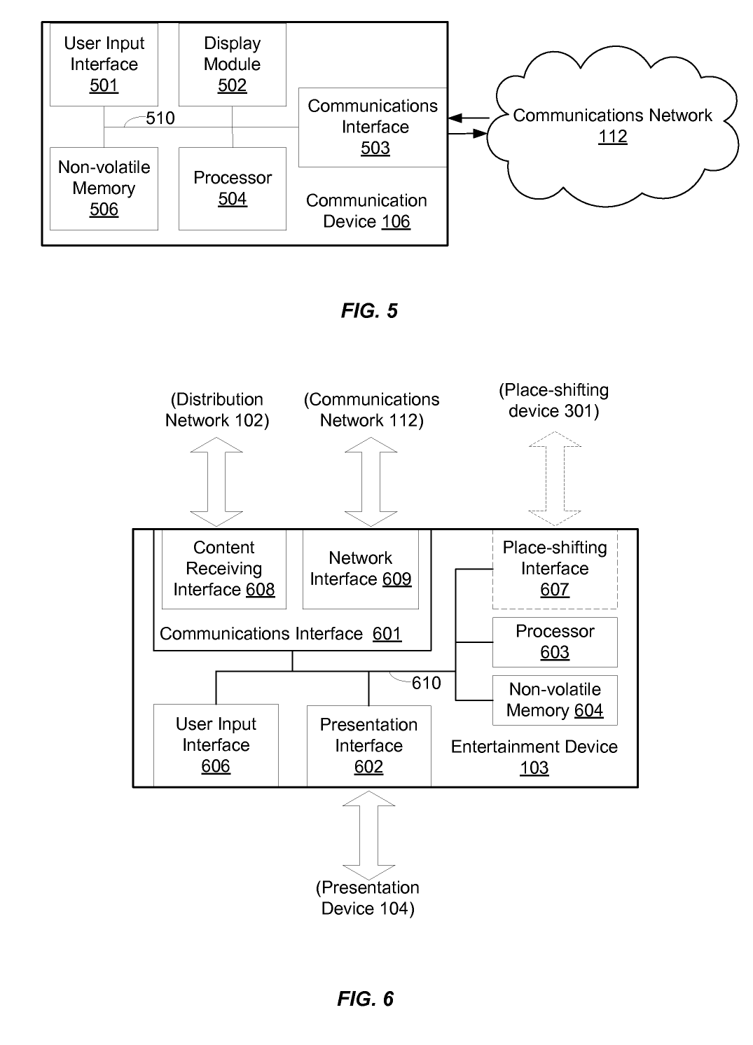

FIG. 5 depicts an embodiment of a communication device 106. In various embodiments, communication device 106 may be a laptop computing device, desktop computing device, tablet computing device, smart phone, portable handheld electronic device, other portable computing device, set top box, and the like. The various components of communication device are depicted as being connected via a bus 510. The bus 510 and the connections thereto that are depicted in FIG. 5 are merely illustrative; the components of the communication device 106 may be connected in any of several configurations using any number of buses or other connections. Further, FIG. 5 is merely an illustration of an embodiment of a communication device 106, and it is understood that the components thereof may be implemented either functionally or logically, as hardware or as software, and may be integrated into consolidated units or separated into multiple units beyond what is depicted in the example embodiment shown in FIG. 5.

Communication device 106 includes a communications interface 503 which is communicatively coupled to communications network 112 and receives scheduling information regarding recommended programs. Each recommended program is scheduled to be broadcast to an entertainment device via a content distribution network during at least a portion of a predetermined future time period. The communication device 106 and the entertainment device may pertain to the same user. For example, the communication device may be a user's portable electronic communication device (such as a smart phone or tablet PC), and the entertainment device may be the user's set top box at home, which is connected to a video content broadcasting source.

In at least one embodiment, communications interface 503 is configured to receive, through the communications network 112, the scheduling information from a recommendations engine that is separate from both the entertainment device and the communication device 106. In other embodiments, the communications interface 503 is configured to receive the scheduling information from the entertainment device, through the communications network 112.

Communication device 106 further includes a display module 502 that is configured to present the scheduling information regarding the recommended programs to a user of the communication device 106. Display module 502 may comprise an LCD screen, a computer screen, a touch screen, or other display apparatus configured to present the recommended programs to the user of the communication device.

A user input interface 501 of the communication device 106 is configured to receive, from a user of the communication device 106, one or more user selections of one or more programs of the recommended programs. The user selections may request that a timer associated with a selected program be set at the corresponding entertainment device. The timer may specify that a particular task associated with the selected program be performed at the entertainment device. Such a task may comprise a recording task, a reminder task, an auto-tune task, a place-shifting task, and so forth. User input interface 501 may be implemented as a touch device, keyboard, mouse, optical input device, or other input device that is connected to and compatible with the other elements of communication device 106. In some embodiments, both display module 502 and user input interface 501 may be integrated as a single touch screen device that is coupled to other components of the communication device 106.

The communications interface 503 of communication device 106 may also be configured to initiate transmission of the one or more user selections selected by a user via the user input interface 501 to an entertainment device to which the recommended programs are scheduled to be broadcast during the predetermined future time period. The user selections correspond to one or more of the recommended programs and request that a timer be set at the entertainment device. In some embodiments, user selections may specify which timers of a plurality of available timers are to be set. Upon receiving the user selections, the entertainment device sets corresponding timers to execute the associated tasks.

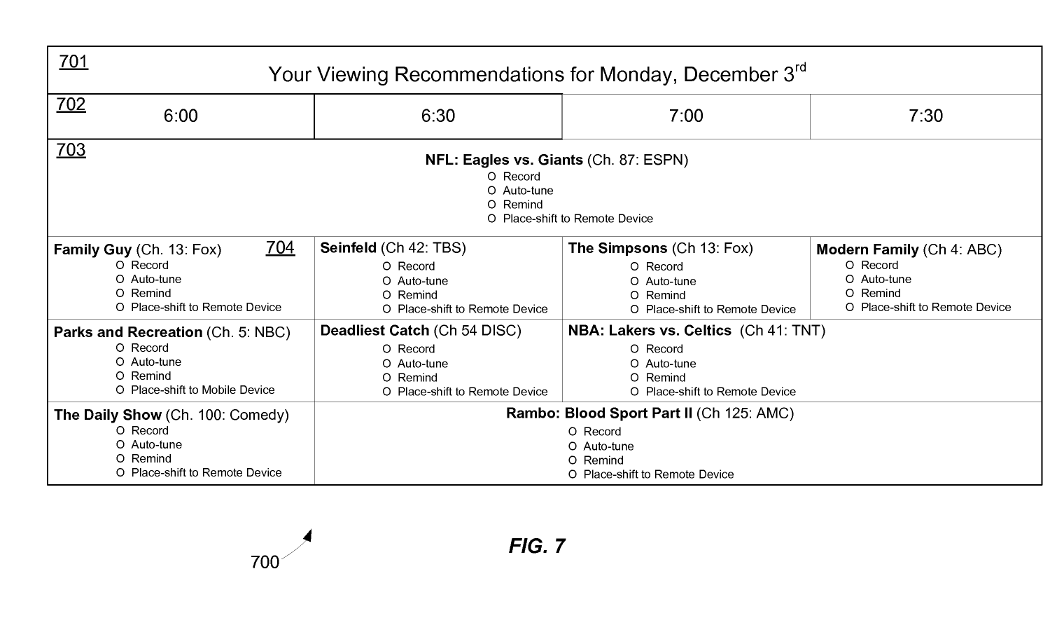

A processor 504 is also included in communication device 106. In some embodiments, processor 504 may process programming recommendation data that is received via communications interface 503 in order to provide for a graphical display of the data by the display module 502. For example, in one embodiment, processor 504 may process received programming recommendation information, including scheduling information, regarding recommended programs. The processor may then arrange and/or format the data for presentation in an interactive graphical presentation format that is displayable via display module 502. In such an embodiment, the interactive graphical presentation format is configured to provide for user interaction—via the user input interface 501—with the information. The user interaction may be user selection of one or more programs of the recommended programs and/or user selection of one or more timers corresponding to the selected programs (e.g., via a touch screen interface). An example graphical presentation format for programming recommendations is depicted in FIG. 7 and will be discussed in more detail in turn.

Communication device 106 also includes non-volatile memory 506, which may be implemented as a hard disk, solid-state drive, flash memory, or other non-volatile memory. Non-volatile memory 506 may be utilized by communication device 106 to store, for any amount of time, data regarding programming recommendations.

FIG. 6 depicts an embodiment of an entertainment device 103. Various devices, networks and systems to which entertainment device 103 connects or interfaces are depicted in parentheses in FIG. 6 for reference, for example, distribution network 102, communications network 112, presentation device 104, and, optionally, place-shifting device 301. Entertainment device 103 includes a bus 610, which connects each of the numbered components with one or more of the other components. Similarly to the bus 510 of communication device 106, the bus 610 and the connections thereto that are depicted in FIG. 6 are merely illustrative, and any number of buses or configurations may be implemented. Further, FIG. 6 is merely an illustration of an embodiment of an entertainment device 103, and it is understood that the components thereof may be implemented either functionally or logically, as hardware or as software, and may be integrated into consolidated units or separated into multiple units beyond what is depicted in the example embodiment shown in FIG. 6.

Entertainment device 103 comprises communications interface 601 which includes a content receiving interface 608 and a network interface 609. In some embodiments, content receiving interface 608, connecting to distribution network 102, and network interface 609, connecting to communications network 112, may be physically separate hardware components. In other embodiments, the two interfaces may be implemented as a single hardware component that is logically partitioned (whether by hardware or software) into components that communicate with the distribution network 102 and with the communications network 112. In yet other embodiments, distribution network 102 and communications network 112 may be a single network, upon which both programming content and network communications are communicated, and content receiving interface 608 and network interface 609 may be integrated as a single component.

The content receiving interface 608 receives video content from distribution network 102. Presentation interface 602 outputs received video content to a corresponding presentation device 104 for display thereon. In some embodiments, display device 104 may be integrated with entertainment device 103. Entertainment device 103 additionally includes non-volatile memory 604 for storage of data, including, in at least one embodiment, for DVR storage of recorded received programming content and/or storage of application code. In some embodiments, presentation device 104 may have a place-shifting interface 607, which interfaces with a place-shifting device 301. (The place-shifting interface 607 is depicted in dashed lines to indicate that the place-shifting interface and device are optional.) In some embodiments, place-shifting device 301 may be integrated with entertainment device 103 as one apparatus.

Entertainment device 103 additionally includes a processor 603 that, in some embodiments, generates programming recommendations. In other embodiments, programming recommendations are generated at a separate recommendations engine. Programming recommendations may correspond to programs that are scheduled to be broadcast to the entertainment device during a predetermined future time period. In some embodiments, programming recommendations may be generated based on user viewing preferences that are input to the entertainment device or other device by a user. In at least one embodiment, processor 603 may track a user's viewing history, and programming recommendations may be automatically generated based on the tracked history and/or other trackable and quantifiable viewing habits or preferences. In some embodiments, recommendations may be generated according to other recommendation generation mechanisms that are disclosed herein or that are compatible herewith.

In at least one embodiment, the network interface 609 of communications interface 601 may be configured to initiate transmission of information, including scheduling information, regarding the programming recommendations generated by the processor 603 to a communication device that is external to the entertainment device 103. In at least one embodiment, the network interface 609 is configured to receive, from the external communication device, one or more user selections of recommended programs of the programming recommendations that were transmitted to the communication device. In some embodiments, user selections may request that one or more timers corresponding to the selected programs be set at the entertainment device 103.

In at least one embodiment, responsive to the network interface 609 receiving one or more user selections of programs, processor 603 may set one or more timers to perform one or more tasks associated with the user selections. Tasks may include recording a selected program, providing a reminder regarding a selected program begin time, automatically tuning to a selected program, and/or place-shifting a selected program. A timer for a selected program may correspond to a time or time slot associated with the scheduling information of a selected program. Further, the processor 603 executes a task corresponding to a timer when a time associated with the timer has arrived or is arriving shortly.

There are various ways of displaying viewing recommendations and facilitating user selection of recommended programs at a communication device. FIG. 7 depicts an example interactive graphical representation of viewing recommendations 700 according to at least one embodiment. Other representations of viewing recommendations may be utilized, some of which may include elements in addition to those depicted in FIG. 7, and some of which may omit elements depicted in FIG. 7.

Interactive graphical representation 700 includes a title bar 701 that indicates a date to which the viewing recommendations correspond. The viewing recommendations are organized by time slots, for example time slot 702 represents the half-hour programming period from 6:00 until 6:30. Any number of recommended programs may be presented to the user for selection during each time slot. Some recommended programs may span multiple time slots; for example, a recommended program 703 that is a football game may span two hours or more. Other recommended programs may span merely a single half hour time period as seen in recommended program 704.

The example graphical representation of viewing recommendations 700 includes user interface elements which provide for user selection requesting different timers to be set with respect to programming recommendations. In this example, a user may choose to record, auto-tune, remind, or place-shift to a remote device (e.g. communication device) at a future time corresponding to the program's time slot. In some embodiments, the user may be limited as to how many programs can be selected and as to what timers may be set for a given time period based on capabilities of the user's entertainment device. For example, a user may have a set top box with two tuners, each of which can record, present and/or place-shift a program. The timers that could be set would be thus limited by the capabilities of the set top box. A user with such a device could select to auto-tune to a first program 703 during a first time slot 702 and record a second program 704 during the same time slot. However, the user may be restricted from setting timers for other programs with overlapping time slots since both tuners will be in use at that time. In some embodiments, the actions a user may take may be limited based on other device capabilities or other criteria. For example, some implementations may only provide for scheduling recording timers, or other embodiments, where a device has no recording capabilities, may only provide for scheduling auto-tune timers and/or reminders.

The graphical representation of viewing recommendations 700 may be presented to user on user's communication device via an application installed on the viewing device, may be accessible as a web page or web application, or may be sent to the communication device as a graphical element of an email or other electronic message.

In at least one embodiment, user selections may be displayed in a further graphical display of a selected schedule for the predetermined future period. In such an embodiment, as a user selects one or more timers (which could be, for example, an auto-tune, recording, reminder, place shifting timer, or the like) to be set at the user's entertainment device during the predetermined future time period, a schedule for the time period is generated. A graphical display of the schedule of selected programming timers may be displayed simultaneously with a graphical interface that facilitates the selection, such as graphical representation of viewing recommendations 700, or may be displayed in a subsequent screen or graphical rendering.

Presentation formats that are different than FIG. 7 may also be implemented in at least one embodiment. For example, viewing recommendations may be presented to a user in an electronic message (e.g., email or SMS) sent to user in a textual and/or graphical format. In such embodiments, the user may provide selections of programs by interfacing with one or more interactive elements of the electronic message. In other embodiments, the user may reply to the electronic message in a pre-defined manner that indicates to an entertainment device or recommendations engine the user's selection(s).

As an example of such an embodiment, each recommended program could be presented in the electronic message with a corresponding unique number or other identifier. The user could simply send a reply to the electronic message containing the identifiers of programs for which the user would like timers set. For example, in an embodiment where timers may be set to auto-tune an entertainment device to a given program, there may be four recommendations for a first time slot, which are given identifiers 1, 2, 3, and 4 along with corresponding program information, and four recommendations for a second time slot, given identifiers 5, 6, 7, and 8 along with corresponding program information. The user may elect to auto-tune to program 1 for the first time slot and program 6 for the second time slot and would thus send a responsive message containing the two identifying numbers (e.g., “1 6”), which would be processed to set the auto-tune timers at the entertainment device.

In an extension of this example, a user could add an additional identifier to the program identifier to indicate an action to take with respect to the program. In such an example, there may be preset action identifiers (e.g., R to record, A to auto-tune, and P to place-shift.) If the user in this example wanted to auto-tune to program 1, record program 3, place-shift program 5, and record program 7, the user would respond to the email with “1A 3R 5P 7R”, which message would be processed and the corresponding timers would be set at the user's entertainment device.

Although specific embodiments were described herein, the scope of the invention is not limited to those specific embodiments. The scope of the invention is defined by the following claims and any equivalents therein.

I claim:

1. In a content distribution network, a method, comprising:
generating a plurality of programming recommendations, which correspond to a plurality of recommended programs that are scheduled to be broadcast to an entertainment device via the content distribution network during a predetermined future time period;
transmitting information regarding the plurality of programming recommendations to a communication device that is separate from the entertainment device, the communicated information comprising scheduling information regarding the plurality of recommended programs;
receiving, from the communication device, a user selection corresponding to a program of the plurality of recommended programs; and
generating an instruction requesting that a timer be set at the entertainment device to perform a task associated with the selected program.

2. The method as claimed in claim 1, wherein the operations of generating the plurality of programming recommendations, transmitting the information regarding the programming recommendations, receiving the user selection from the communication device, and generating the instruction are performed by a recommendations engine comprising one or more hardware components that are communicatively connected to the entertainment device and the communication device by at least one communications network.

3. The method as claimed in claim 1, wherein the operations of generating the plurality of programming recommendations, transmitting the information regarding the programming recommendations, receiving the user selection from the communication device, and generating the instruction are performed by the entertainment device, which is communicatively connected to the communication device through a communications network.

4. The method as claimed in claim 1, wherein the timer comprises a recording timer to record the selected program at the entertainment device during a time slot corresponding to the scheduling information regarding the selected program.

5. The method as claimed in claim 1, wherein the timer comprises a reminder timer that presents, at a time that is associated with a beginning time of the selected program, a reminder indicating that the program is scheduled to begin.

6. The method as claimed in claim 1, wherein the timer comprises an auto-tune timer that automatically tunes the entertainment device to the selected program at a time that is associated with a beginning time of the selected program.

7. The method as claimed in claim 1, wherein the timer comprises a place-shifting timer that causes the entertainment device to place-shift the program to the communication device beginning at a time that is associated with a beginning time of the selected program.

8. The method as claimed in claim 1, wherein transmitting information regarding the plurality of programming recommendations to the communication device further comprises:
sending an electronic message, selected from an e-mail message and a text message, to the communication device that facilitates the user selection corresponding to one of the plurality of recommended programs.

9. The method as claimed in claim 8, further comprising:
receiving a response, formatted in a predefined manner, from a user of the communication device that provides the user selection corresponding to one of the plurality of recommendations.

10. The method as claimed in claim 1, further comprising:
providing an application to the communication device, which presents a graphically organized display of the plurality of recommendations, and which is configured to receive user input, comprising a plurality of user selections corresponding to two or more of the plurality of recommended programs, wherein the plurality of user selections are transmitted to the entertainment device.

11. The method as claimed in claim 1, further comprising:
generating a plurality of programming recommendations corresponding to a predetermined future time period each day of a fixed set of days in a week, wherein the predetermined future time period corresponds to a predetermined range of viewing times during each of the fixed set of days; and
communicating the information regarding the plurality of programming recommendations, including scheduling information, to the communication device at a predetermined time each day of the fixed set of days.

12. A communication device, comprising:
a communications interface that receives scheduling information regarding a plurality of recommended programs corresponding to a predetermined future time period, wherein each recommended program is scheduled to be broadcast via a content distribution network to an entertainment device during the predetermined future time period;
a display module that presents the scheduling information regarding the plurality of recommended programs to a user;
a user input interface which receives a selection from the user of a program of the recommended programs, the user selection requesting that a timer be set at the entertainment device to perform a task associated with the selected program; and
the communications interface initiating transmission, to the entertainment device, of the user selection, wherein the entertainment device is configured to set the timer corresponding to the user selection.

13. The communication device of claim 12, wherein the communications interface receives the scheduling information through a communication network from a recommendations engine that is separate from the entertainment device and the communication device, and wherein the user selection is transmitted to the recommendations engine for processing thereat.

14. The communication device of claim 12, wherein the communications interface receives the scheduling information from the entertainment device through a communications network and directly transmits the user selection to the entertainment device through the communications network.

15. The communication device of claim 12, wherein the communications interface receives an electronic message comprising the scheduling information, and
the user input interface receives an interaction from the user of the communication device with content of the electronic message, the interaction comprising the user selection of one or more of the recommended programs for which to set the timer at the entertainment device.

16. The communication device of claim 15, wherein the electronic message is an email or text message and the interaction with the electronic message comprises a reply to the message using predefined criteria that indicate the user selection.

17. The communication device of claim 15, wherein the interaction with the electronic message comprises a user interaction with one or more interactive content elements contained within the message.

18. The communication device of claim 12, further comprising:
the display module is further configured to present an application, the application comprising
a graphical presentation of the scheduling information regarding the plurality of recommended programs, and
one or more interactive user interface elements which provide for the user selection of one or more of the recommended programs in order to set a timer therefor; and
the user input interface is further configured to receive a user input associated with at least one of the interactive user interface elements of the application to request that a timer be set at the entertainment device for one or more of the recommended programs.

19. The communication device of claim 12, wherein
the timer to be set at the entertainment device comprises a timer to place-shift the selected program to the communication device during a time slot in which the selected program is scheduled to air;
the communications interface is configured to receive the place-shifted program during the time slot; and
the display module is configured to display the place-shifted program.

20. An entertainment device, comprising:
a communications interface, communicatively coupled to a video content distribution network, that receives video programming from a content source;
a presentation interface that outputs the received video programming to a presentation device for display thereon;
a processor coupled to the receiving interface that generates a plurality of programming recommendations that correspond to a plurality of recommended programs that are scheduled to be broadcast to the entertainment device during a predetermined future time period;
the communications interface, coupled to the processor and communicatively coupled to a communications network, that
transmits information, including scheduling information corresponding to the plurality of recommended programs, regarding the plurality of programming recommendations to a communication device that is separate from the entertainment device;
receives, from the communication device, a user selection of a program of the plurality of recommended programs; and
the processor, responsive to the communications interface receiving the user selection,
sets a timer to perform a task requested by the user selection at a time corresponding to the scheduling information of the selected program, and
executes the task according to the timer.

21. The entertainment device of claim 20, wherein the processor is configured to track user viewing history and automatically generate the programming recommendations based at least in part on the tracked user viewing history.

22. The entertainment device of claim 20, wherein the processor generates the programming recommendations based at least in part on a plurality of user viewing preferences that are input to the entertainment device by the user.

23. The entertainment device of claim 20, wherein the timer is a place-shifting timer that causes the entertainment device to place-shift the program to the communication device beginning at the start of a time slot corresponding to the scheduling information regarding the selected program.
